(19) United States
(12) Patent Application Publication
(10) Pub. No.: US 2010/0121673 A1
(43) Pub. Date: May 13, 2010

(54) MESSAGE NOTIFICATION METHOD, WORK MANAGEMENT DEVICE, AND COMPUTER PROGRAM

(76) Inventors: Motohiko Sakaguchi, Tokyo (JP); Hidekazu Sakagami, Tokyo (JP)

Correspondence Address: Mr. Jackson Chen, 6535 N. STATE HWY 161, IRVING, TX, 75039, US

(21) Appl. No.: 12/528,143

(22) PCT Filed: Feb. 22, 2008
(86) PCT No.: PCT/JP2008/053590

§ 371 Date: Aug. 21, 2009

(30) Foreign Application Priority Data
Feb. 26, 2007 (JP) 2007-045374

(51) Int. Cl. G06Q 10/00

(52) U.S. Cl. 705/9; 705/301

(57) ABSTRACT

A work management device having a plurality of notification devices of which corresponding notification manners are different from each other and managing jobs performed by a plurality of workers notifies a message to part or all of the plurality of workers. When the work management device has changed job information stored in advance in a storage device of the work management device, the work management device calculates an importance of a change of the job information for each of the plurality of workers, selects one or more from the plurality of notification devices according to the calculated importances, and notifies each of the pertinent workers of a message relating to the change of the job information by the use of the selected notification device.

### TECHNICAL FIELD

This invention relates to a system (hereinafter referred to as a work management system) that manages the progress of work according to a job flow, defined in advance, for the purpose of increasing the efficiency of the work and standardizing the same. This invention particularly relates to a work management system that properly notifies workers of a change in job flow, job staff, job progress, or the like when managing the work progress of jobs of which a job flow is progressively determined.

### BACKGROUND ART

On a production line in a factory, the working time in each process falls within a fixed range regardless of workers. Therefore, it is possible to define a job flow by expecting the working time in each process. Further, since the working time is expectable, the current job progress can also be accurately expected to some degree. Hereinafter, this type of jobs will be referred to as typical jobs and work composed of the typical jobs will be referred to as typical work. In the case of the typical work, it is basically not necessary to frequently update a job flow once established.

On the other hand, in office work such as preparation of a planning report, the working time in each process largely differs depending on the content of a planning report to be prepared, the skill of a worker, or the like. Further, it may happen that job allotment is changed depending on a progress state of jobs. As a result, even if a job flow of this type of jobs is defined before the start of the jobs, the current job progress cannot be expected from the job flow. For managing the actual work progress, it is necessary to frequently update a job flow, a job progress, a job staff name, and so on according to the actual job progress. Jobs of the type in which it is necessary to progressively determine a detailed job flow, job progress, job allotment, and so on while actually advancing the jobs as described above will hereinafter be referred to as atypical jobs. From such nature, it is difficult to define a job flow of atypical work in advance.

As described above, in order to smoothly advance the atypical work, a work management system is required to be capable of flexibly changing a job flow. Further, it is necessary to frequently notify persons concerned in jobs of dynamically changed job content such as a change in job flow, a change in job staff, or a change in job progress.

Conventionally, in a work management system that manages typical work, there has been widely and generally employed a mechanism of notifying a next job staff member by electronic mail or the like at a time when a preceding job has been completed. Further, a technique about work management of atypical work is described in Japanese Unexamined Patent Application Publication (JP-A) No. 2004-355520 or Japanese Unexamined Patent Application Publication (JP-A) No. 2005-032073, wherein, likewise, notification is made to a next job staff member at a time when a preceding job has been completed.

### DISCLOSURE OF THE INVENTION

### Problem to be Solved by the Invention

Regardless of typical work or atypical work, in order to efficiently advance jobs, it becomes important that workers carry out their own jobs while grasping a job flow of the whole of the jobs.

In the typical work, it is possible to define a job flow and make it known to each user in advance. Therefore, in the prior art relating to the typical work, notification is made to each user when his or her turn of a job has come. By this, the users can carry out their own jobs while grasping a job flow of the whole of the jobs.

On the other hand, since a job flow is progressively determined in atypical jobs, the whole of the jobs cannot be grasped even by referring to a job flow prepared before the start of the jobs. For grasping the whole of the jobs, it is necessary to grasp a change generated not only in a job immediately before or after a job in his/her own charge, but also in the whole of the jobs. However, in the conventional work management of the atypical work, since notification is only made to each user that a turn of his/her own job has come, the users cannot grasp the whole of the jobs and thus it is difficult to efficiently advance the jobs. Taking preparation of a planning report as an example, in order to prepare appropriate materials, it is preferable to know why the material is prepared and how the material will be used.

If all changes are notified to all users upon the occurrence of changes, the whole of jobs can be notified to all users formally. However, if doing like this, since changes of jobs are frequently generated particularly in atypical jobs, there occurs a situation where each user receives a lot of notifications so that the notification informing a change important to a user is mixed among the other change notifications that are not important for the user and, as a result, the user cannot recognize the presence of the notification about the important change.

This invention has been made under these circumstances and a subject to be solved by this invention is to provide a technique of making notification, per user at need, of a change generated in the whole of jobs when managing work such as atypical work in which job changes frequently occur.

### Means for Solving the Problem

In order to solve the above subject, this invention provides the following message notification method, work management device, work management system, and computer program.

That is, this invention provides a message notification method in which a work management device managing jobs performed by a plurality of workers notifies a message to part or all of the plurality of workers, wherein the work management device comprises a plurality of notification devices of which corresponding notification manners are different from each other, the method comprising a data changing step (step A1) in which the work management device changes job information stored in advance in a storage device of the work management device, an importance calculation step (step A4) in which the work management device performs a process of calculating an importance of a change of the job information for each of the plurality of workers, a notification device selection step (step C1, D1) in which the work management device performs a process of selecting one or more from the plurality of notification devices according to the importances calculated, and a notification step (step C3, D2) in which the work management device notifies each of the pertinent workers of a message relating to the change of the job information by the use of the notification device selected.

Further, this invention provides a work management system comprising a communication network, a plurality of input/output devices connected to the communication network, and the above work management device connected to the communication network, the work management system wherein means for changing the job information changes the job information in response to an input operation of the input/output device and the selected notification device notifies each of the pertinent workers of the message relating to the change of the job information through the communication network and the input/output device.

Further, this invention provides a computer program that causes a computer to perform a work management process for managing jobs performed by a plurality of workers, the computer comprising a plurality of notification devices of which corresponding notification manners are different from each other, and the computer program causing the computer to execute a step of changing job information stored in advance in a storage device (step A1), an importance calculation step of calculating an importance of a change of the job information for each of the plurality of workers (step A4), a step of selecting one or more from the plurality of notification devices according to the importances calculated (step C1, D1), and a step of notifying, by a work management device, each of the pertinent workers of a message relating to the change of the job information by the use of the notification device selected (step C3, D2).

### EFFECT OF THE INVENTION

According to this invention, since it is possible to notify a message in a different notification manner between a case where an importance of a change of job information is high and a case where it is low, it is possible to more securely deliver an important message to a recipient. Particularly, in atypical work, changes of job information frequently occur and thus it is necessary to frequently notify messages notifying the changes. As a result, a recipient receives a lot of messages. Even in such a case, however, the recipient can easily identify important messages based on the difference in notification manner. Further, simultaneously, according to this method, since an importance is calculated per worker, notification can be made as a high importance message to a worker under great influence of a change, while, notification can be made as a low importance message to a worker under small influence thereof.

### BRIEF DESCRIPTION OF THE DRAWINGS

FIG. 1 is a functional block diagram of a work management system 1000 being an Example 1 of this invention.

FIG. 2 is a diagram for explaining an example of a job flow.

FIG. 3 is job flow data corresponding to the job flow of FIG. 2.

FIG. 4 is a diagram for explaining an example of worker data.

FIG. 5 is a diagram for explaining an example of job staff data.

FIG. 6 is a diagram for explaining an example of job progress data in the job flow of FIG. 2.

FIG. 7 is a diagram for explaining an example of a job display shown on a screen of an input/output device 1.

FIG. 8 is a diagram for explaining an example of notification device management data.

FIG. 9 is a diagram for explaining an example of notification data.

FIG. 10 shows examples of importance calculation tables, wherein (a) is a case where the number of fixed-term direct notifications is smaller than a predetermined number and (b) is a case where the number of fixed-term direct notifications is greater than the predetermined number.

FIG. 11 is a flowchart for explaining a process from an input of a job change from an input/output device 1 to the generation of notification data in a work management device 3, in the work management system 1000.

FIG. 12 is a flowchart for explaining a process of importance calculation by an importance calculation section 37 in the work management device 3.

FIG. 13 is a flowchart for explaining the operation of the work management system 1000 when notifying notification content based on direct notification.

FIG. 14 is a flowchart for explaining the operation of the work management system 1000 when notifying notification content based on indirect notification.

FIG. 15 is a diagram for explaining an example of notification content generated/sent by a mailer when the mailer is selected, as a notification device 5 for sending notification content, in step C1 in FIG. 13.

FIG. 16 is a diagram for explaining an example of a screen displayed on a screen of an input/output device 1 by an indirect notification section 35 through a job display section 35 when both message display and update display are selected as indirect notification methods in step D1 in FIG. 14.

FIG. 17 is a functional block diagram of a work management system 2000 being an Example 2 of this invention.

FIG. 18 is a diagram for explaining an example of an importance calculation table referred to by an importance calculation section 37 in the work management system 2000.

In FIG. 19, (a) to (c) are diagrams for explaining management states when the work management system 1000 is applied to specific atypical jobs as an Example 3 of this invention.

### BEST MODE FOR CARRYING OUT THE INVENTION

A work management system being an embodiment of this invention will be described. The work management system comprises one or more input/output devices 1, a communication network 2, a work management device 3, a storage device 4, and one or more notification devices 5.

The input/output device 1 has an input function for allowing a user to input job information and an output function for allowing perusal of job information and performing a notification display. As a typical one, use can be made of a personal computer, a notebook computer, a mobile tool, or an STB (Set-Top Box), or further, a web browser, a mailer for electronic mail transmission and reception, or the like running on a mobile phone, a PHS, or a PDA (mobile information terminal: Personal Digital Assistant).

The communication network 2 is a conventionally known, arbitrary, suitable, and data communicable communication network. Specifically, the communication network 2 comprises a public network, a commercial network, and various private networks, or a network interconnecting them.

The work management device 3 is a device for carrying out a work management process and, for example, comprises a server computer having a communication interface, and an operating system and a work management program running thereon.

Each of workers in charge of respective jobs in a job flow makes an input using the input/output device 1. Further, by outputting various notifications, generated by the work management device 3, using the input/output device 1, each worker knows the notification contents. When one of the workers has input a change point about a job management, such as a job flow, a change in staff, or a job progress, using the input/output device 1, the work management device 3 evaluates an importance of the change point per worker and notifies each worker of change content using a notification means corresponding to the importance.

The valuation of the importance is carried out according to the kind of change content. Further, assuming that a distance is defined between two jobs included in a job flow and this distance is called a job distance, the work management device 3 derives a job distance between a job subjected to a change and a job in charge of a worker to be notified and refers to it when deriving an importance. The change is evaluated as a high importance change for a worker in charge of a job near the job subjected to the change in the job flow, while, the change is evaluated as a low importance change for a worker in charge of a job far from it.

Since notification is made to each worker using a notification means that differs according to an importance, the worker can know, to some degree, an importance of the notification only from the notification means receiving the notification. Further, since high importance notification is sent by a notification means corresponding thereto, it can be prevented from being mixed among low importance other notifications. Particularly, it is considered that, to a worker for whom an importance of a generated change is evaluated high, the occurrence of the change is notified without waiting for an operation by the worker to be notified, i.e. based on push-type information delivery, while, to a worker for whom an importance of the generated change is evaluated low, the occurrence of the change is notified in response to an operation by the worker, i.e. based on pull-type information delivery.

### EXAMPLE 1

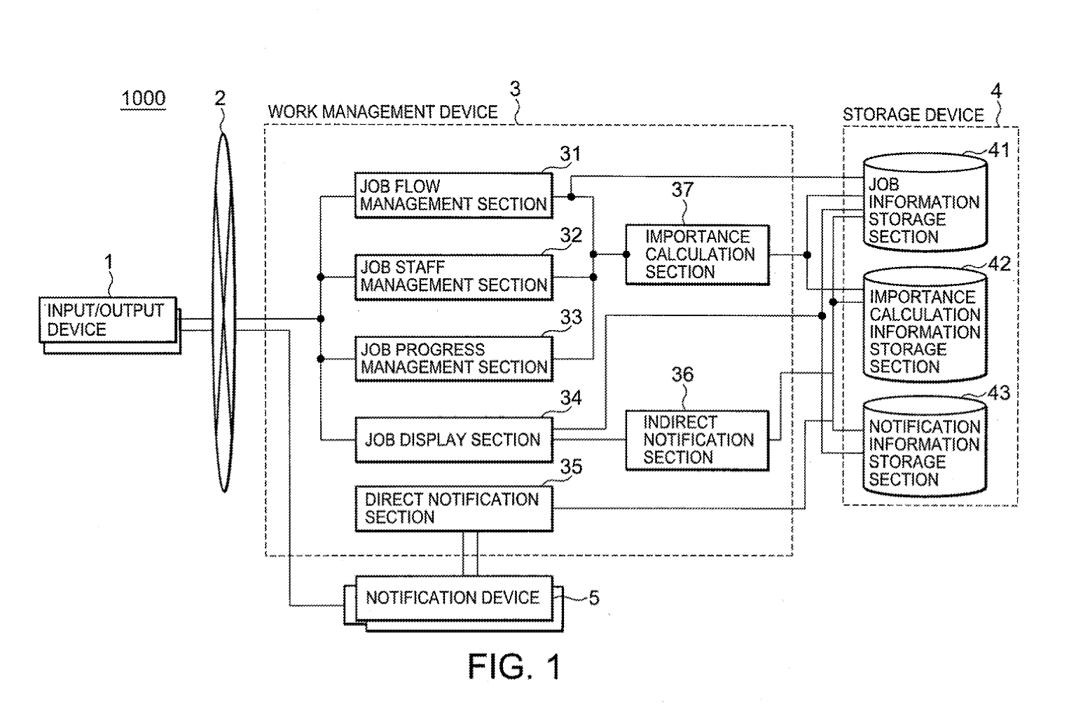

A work management system 1000 being an Example 1 of this invention will be described. Referring to FIG. 1, the work management system 1000 comprises one or more input/output devices 1, a communication network 2, a work management device 3, a storage device 4, and one or more notification devices 5.

The work management device 3 comprises a job flow management section 31, a job staff management section 32, a job progress management section 33, a job display section 34, a direct notification section 35, an indirect notification section 36, and an importance calculation section 37.

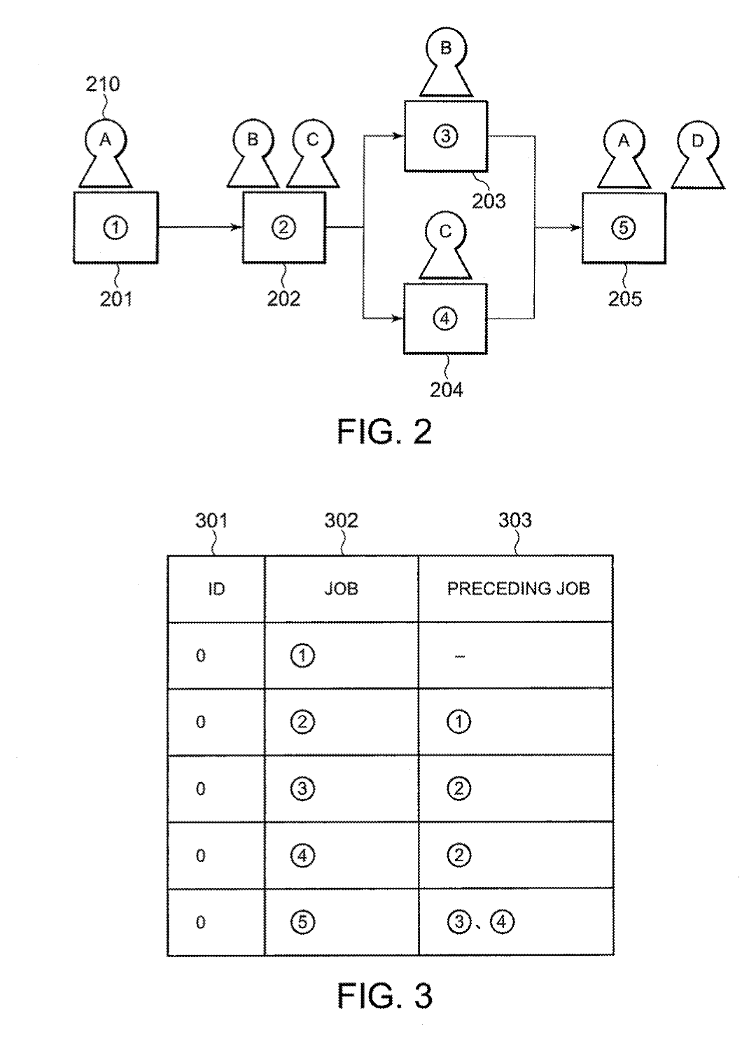

Referring to FIG. 2, a description will be given of an example of work managed by the work management device 3 The work shown in FIG. 2 represents a job flow in which a job 2 (202 in FIG. 2) is performed next to a job 1 (201 in FIG. 2), then a job 3 (203 in FIG. 2) and a job 4 (204 in FIG. 2) are performed in parallel, and finally a job 5 (205 in FIG. 2) is performed. Hereinbelow, 201, 202, 203, 204, and 205 in FIG. 2 and so on will be called jobs and what is formed by a series of one or more jobs will be called a job flow. A person (210 in FIG. 2) above the job represents that a worker A is in charge of the job 1. Likewise, persons above the jobs 2 to 5 also represent that they are in charge of the respective jobs. In the figure, the jobs 1 to 5 are denoted by circle numbers.

The job flow management section 31 carries out processes of managing job flow data stored in a job information storage section 41. Specifically, the job flow management section 31 carries out processes of registering new job flow data into the job information storage section 41, deleting job flow data from the job information storage section 41, and adding/deleting/changing a job with respect to job flow data stored in the job information storage section 41. A job flow is defined by individually adding jobs or is defined by quoting a past job flow. FIG. 3 shows an example of job flow data corresponding to the example of FIG. 2. The job flow data comprises Job Flow ID for uniquely identifying a job flow (301 in FIG. 3), Job (302 in FIG. 3), and Preceding Job of a job concerned (303 in FIG. 3).

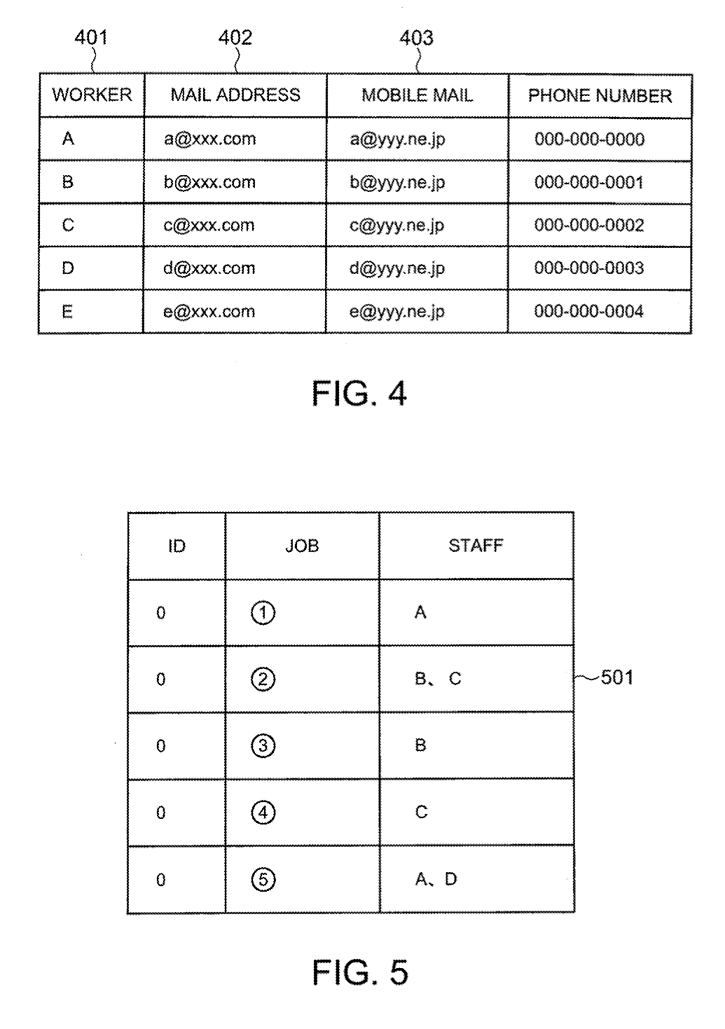

The job staff management section 32 carries out a process of adding/deleting a staff member to/from a job. Designation of a staff member is performed by selection from a list of worker data (example of FIG. 4) recorded in the job information storage section 41. The worker data is a table mapping each worker to a mail address, a mobile phone mail address, and a phone number of the worker. Information handled in the job staff management section 32 is stored into job staff data recorded in the job information storage section 41. FIG. 5 shows an example of job staff data corresponding to the example of FIG. 2. For example, job staff data at 501 in FIG. 5 represents that staff members of a job 2 are workers B and C.

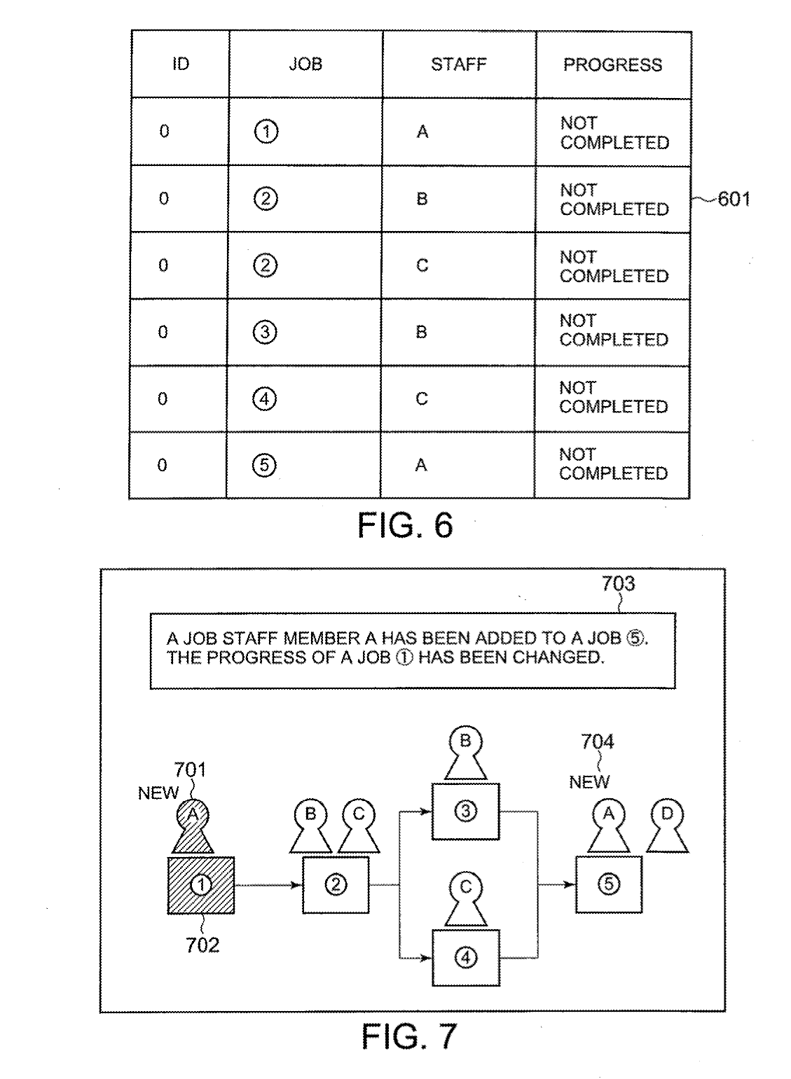

When a job staff member has completed a job, the job progress management section 33 carries out a process of updating the progress to “completed”. The job progress management section 33 also carries out an update process of returning a job with a progress “completed” to “not completed”. Information handled in the job progress management section 33 is stored into job progress data recorded in the job information storage section 41. FIG. 6 shows an example of job progress data corresponding to the example of FIG. 2. Data at 601 in the example of FIG. 6 represents that a worker A has “not completed” a job 1.

The job display section 34 carries out a process of referring to job information, relating to a worker who uses the input/output device 1, in the job information storage section 41 and performing a display on the input/output device 1. The job display section 34 is, for example, a web server. Particularly, when the importance of notification content is low for a worker to be notified, the job display section 34 cooperates with the indirect notification section 36 to show a job display, as illustrated in FIG. 7, on a screen of the input/output device 1, thereby realizing indirect notification.

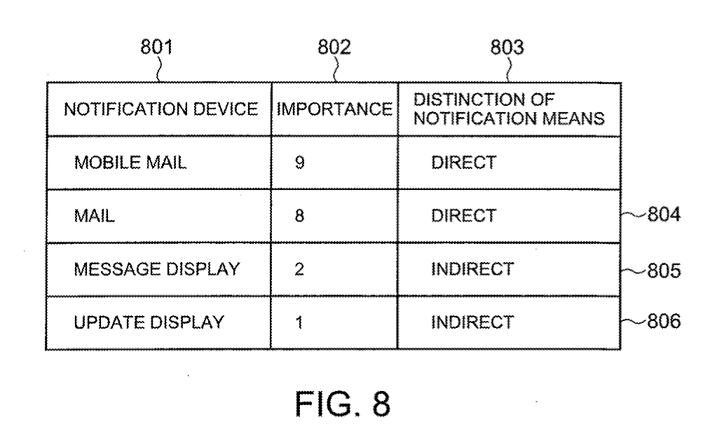

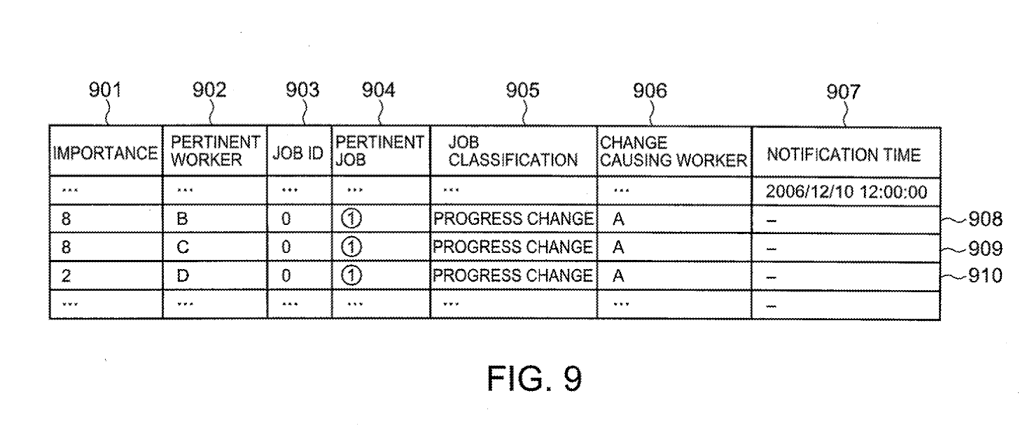

The direct notification section 35 refers to an importance (802 in FIG. 8) of each of notification devices in notification device management data (example of FIG. 8) recorded in an importance calculation information storage section 42 and compares it with importances (901 in FIG. 9) in notification data (example of FIG. 9) recorded in a notification information storage section 43 to determine which is greater or smaller. The notification device management data is a table mapping notification devices, importances thereof, and a distinction between direct notification and indirect notification of each notification device.

The direct notification section 35 is a means for, when the importance of notification content is equal to or greater than that of the direct notification section, referring to a notification destination, such as a mail address (402 in FIG. 4) in the worker data recorded in the job information storage section 41, corresponding to the notification device and carrying out direct notification to a worker using the notification device 5. The direct notification section 35 can perform notification using one or more notification devices 5 and produces notification contents in forms, such as an electronic mail, a mobile phone electronic mail, an instant message a phone, and a fax, suitable for the respective notification devices 5. Notification sent by the direct notification section 35 using the notification device 5 is received by a means, such as a mailer on the input/output device 1, corresponding to a notification method and displayed to a worker.

The indirect notification section 36 carries out a process of referring to indirect notification messages in the notification information storage section 43 and displaying indirect notifications, such as a change message notification (example at 703 in FIG. 7) and an update display (example at 704 in FIG. 7), on a job screen (example of FIG. 7) displayed by the job display section 34. As shown at 703 in FIG. 7, the indirect notification by means of the change message notification is realized by displaying a message above a job display outputted on a display device or the like of the input/output device 1 in response to an operation of the input/output device 1 by a worker. On the other hand, as shown at 701, 702, and 704 in FIG. 7, the indirect notification is realized by performing a display so as to show a job subjected to a change and a worker in charge in a job flow shown at the job display. At 701, the notification is carried out by color-displaying an icon indicating a worker in charge of a job subjected to a change. At 702, the notification is carried out by color-displaying a box indicating the job subjected to the change. At 704, the notification is carried out by displaying “NEW”, indicating that there is an update, near a box indicating a job subjected to a change.

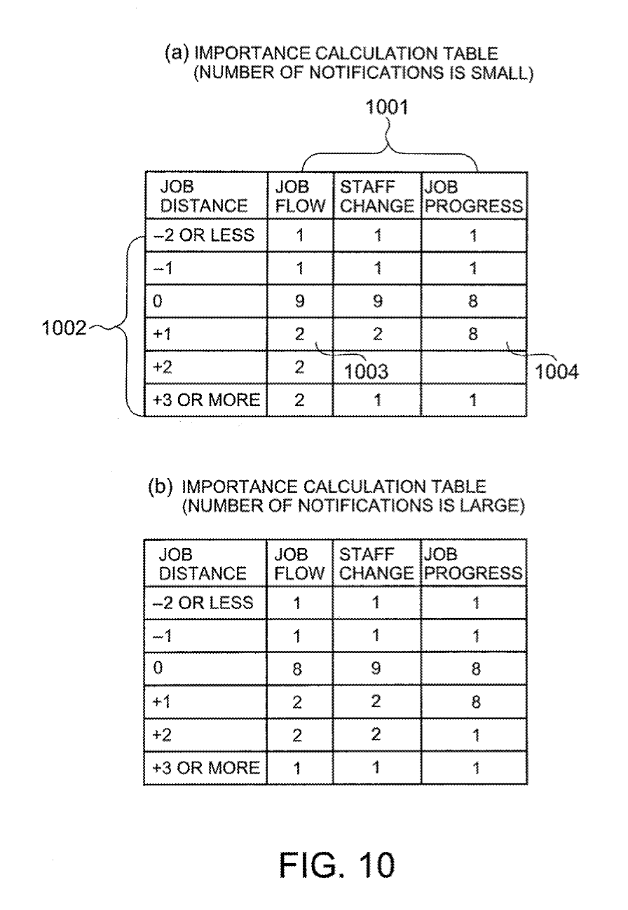

The importance calculation section 37 is a means for calculating an importance by putting together the kind of generated job change (such as job flow change, job staff change, or job progress change; hereinafter referred to as a job classification), the distance between a job subjected to a change and a job of which a worker to be notified is in charge (hereinafter referred to as a job distance), and the number of direct notifications to the worker to be notified within a fixed period of time (hereinafter referred to as the number of fixed-term direct notifications) and for recording notification data in the notification information storage section 43. When a job 1, a job 2, and a job 3 continue in a job flow, the job distances of the job 2 and the job 3 as seen from the job 1 are +1 and +2, respectively. The job distances of the job 1 and the job 2 as seen from the job 3 are −2 and −1, respectively. The importance is calculated by referring to an importance calculation table recorded in the importance calculation information storage section 42. FIG. 10 shows examples of importance calculation tables. There are one or more importance calculation tables and one of them is selected according to the number of fixed-term direct notifications. Basically, when the number of fixed-term direct notifications is large, use is made of an importance calculation table that calculates an importance to be low, while, when it is small, use is made of an importance calculation table that calculates an importance to be high. In the examples of FIG. 10, the importance is judged using two levels, i.e. the table for the case where the number of fixed-term direct notifications is small ((a) in FIG. 10) and the table for the case where the number of fixed-term direct notifications is large ((b) in FIG. 10). The importance calculation table is data expressed in a matrix with the abscissa axis representing the job classification (1001 in FIG. 10) and the ordinate axis representing the job distance (1002 in FIG. 10), wherein importances are set in respective cells. + (plus) of the job distance represents a job (hereinafter referred to as a subsequent job) after a job subjected to a change, while, − (minus) of the job distance represents a job (hereinafter referred to as a preceding job) before a job subjected to a change. To explain an example of importance calculation, when the number of fixed-term direct notifications is small, (a) in FIG. 10 is used for importance calculation so that the importance of notification to a worker in charge of a job immediately after (job distance: +1) a job subjected to a job flow change (job classification: job flow) becomes 2 (1003 in FIG. 10).

The storage device 4 is a device for recording information necessary for the operation of the work management device 3 and comprises the job information storage section 41, the importance calculation information storage section 42, and the notification information storage section 43.

The job information storage section 41 is a storage device that records job information and information about workers. Specifically, the job information storage section 41 records the job flow data (example of FIG. 3), the worker data (example of FIG. 4), the job progress data (example of FIG. 6), and the job staff data (example of FIG. 5) described above.

The importance calculation information storage section 42 records the notification device management data and the plurality of importance calculation tables (examples of FIG. 10) described above. FIG. 8 shows the example of the notification device management data. The notification device management data comprises Notification Device (801 in FIG. 8), Importance (802 in FIG. 8), and Notification Device Distinction (803 in FIG. 8). The importance represents an importance of notification corresponding to its direct notification device or indirect notification device. When an importance calculated by the importance calculation section 37 upon the occurrence of a change is equal to or greater than a specified value, notification is carried out using this notification device.

The notification information storage section 43 records importances of notification to workers and notification contents. Specifically, the notification information storage section 43 records the notification data the example of which is shown in FIG. 9. The notification data comprises Importance of Notification (901 in FIG. 9), Worker to be notified (902 in FIG. 9), Information of Job subjected to a change (903-904 in FIG. 9), Job Classification (905 in FIG. 9), Worker causing a change (906 in FIG. 9), and Time of performing notification (907 in FIG. 9).

The notification device 5 is a device for performing direct notification to a worker. The direct notification is one of message notification manners from the work management device 3 to the input/output device 1 and represents a manner of sending a message to the input/output device 1 from the work management device 3 according to the generation of the message even if a user of the input/output device 1 does not actively perform an operation for reception or the like. In the case of the direct notification, a recipient does not need to voluntarily confirm the presence/absence of a message. For the direct notification, there is, for example, an Internet electronic mail, a mobile phone electronic mail, an instant message, a phone, a fax, or the like. The direct notification can also be said to be notification based on push-type information delivery. The notification device 5 is a device for sending a message based on direct notification and, specifically, there is a mailer or an instant messenger operating on a computer, a fixed phone terminal, a fax terminal, or the like.

On the other hand, the indirect notification is another message notification manner from the work management device 3 to the input/output device 1 and represents a manner in which the input/output device 1 performs confirmation of the presence/absence of a message and reception of the message in response to an active operation by a user. In the case of the indirect notification, a recipient needs to voluntarily confirm the presence/absence of a message. As an example of the indirect notification, there is an electronic bulletin board system. The indirect notification can also be said to be notification based on pull-type information delivery.

Next, the operation of the work management system 1000 will be described giving an example of operation of, upon the occurrence of a change in job progress, delivering change notification for notifying it. It is assumed that the job flow shown in FIG. 2 is defined and, at a time before the start of the operation, the job information storage section 41 stores the job flow data shown in FIG. 3. It is further assumed that the job information storage section 41 stores the worker data of FIG. 4, the job staff data of FIG. 5, and the job progress data of FIG. 6.

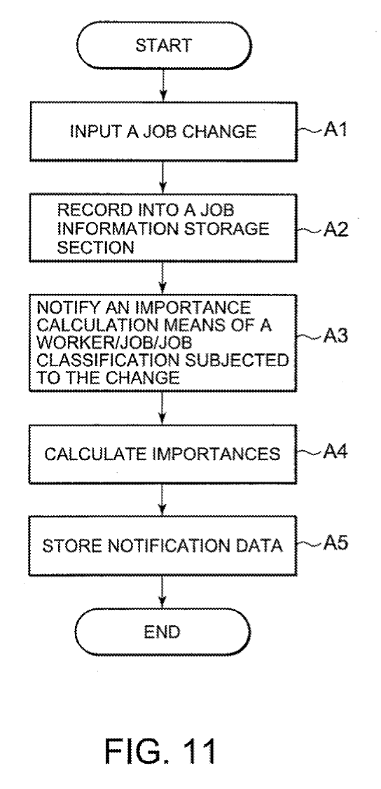

Although the change notification delivery operation includes delivery based on direct notification and delivery based on indirect notification, the process from the occurrence of a change in job progress to the generation of notification data is common to both. This process will be described hereinbelow with reference to FIG. 11.

A worker A having completed a job 1 inputs completion of the job 1 from the input/output device 1. In response thereto, the completion of the job 1 by the worker A is notified to the job progress management section 33 from the input/output device 1 through the network 2 (step A1).

The job progress management section 33 in receipt of this notification accesses the job progress data stored in the job information storage section 41 and updates the progress state of the job 1 from “not completed” to “completed” (step A2).

Then, the job progress management section 33 notifies the importance calculation section 37 of the occurrence of a change (step A3). In this event, the job progress management section 33 notifies the importance calculation section 37 of a worker, job content, and a job classification subjected to the change. In this example, the worker subjected to the change is the worker A, the job content is the job 1, and the job classification is the progress update.

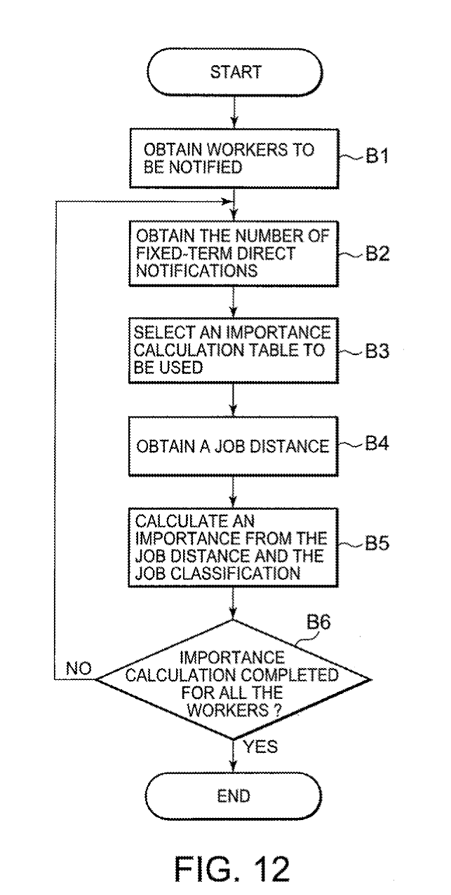

The importance calculation section 37 in receipt of the notification refers to the importance calculation table stored in the importance calculation information storage section 42 and calculates importances (step A4). Herein, referring to FIG. 12, a description will be given of the importance calculation operation of the importance calculation section 37.

First, the importance calculation section 37 extracts workers to be notified of the change in job progress (step B1). Each worker to be notified is a worker in charge of at least one of the jobs forming the job flow of FIG. 2. The importance calculation section 37 selects pertinent workers from the job staff data. According to the job staff data of FIG. 5, the pertinent workers are workers A, B, C, and D. Among them, the worker A himself/herself triggering the notification this time naturally recognizes the completion of the job 1 and thus may be excluded from the workers to be notified.

Then, the importance calculation section 37 calculates an importance for each of the extracted workers. To explain taking the worker B as an example, first, the importance calculation section 37 refers to the notification data stored in the notification information storage section 43 and acquires the number of fixed-term direct notifications to a worker for whom an importance is to be calculated, i.e. the worker B herein (step B2). Herein, a fixed period of time during which the number of fixed-term direct notifications is counted is arbitrarily set in advance by a manager of the work management device 3, for example, the past one day, the past three days, the past one week, or the like.

Then, according to the number of fixed-term direct notifications acquired, the importance calculation section 37 selects, per worker, one of the importance calculation tables stored in the importance calculation information storage section 42 (step B3). Now it is assumed that the importance calculation tables of (a) and (b) in FIG. 10 are stored in the importance calculation information storage section 42 and that (a) in FIG. 10 is applied to a case where the number of direct notifications in the most recent fixed period of time is three or less and (b) in FIG. 10 is applied to a case where the same is four or more.

Then, the importance calculation section 37 refers to the job flow data and the job staff data and calculates, per worker, a job distance from the job 1 subjected to the change (step B4). In the case of this example, of the jobs in charge of the worker B, the distance of the job 2 (202 in FIG. 2) is shortest from the job 1 subjected to the change and is derived as a job distance +1 (a job immediately after a job subjected to a change). If there are jobs in charge before and after a job subjected to a change, the respective job distances before and after the job are calculated.

Then, from the importance calculation table, the importance calculation section 37 acquires an importance corresponding to the acquired job distance (+1 in the example) and the job classification subjected to the change (job progress in the example) (step B5), In the case of this example, the job classification is the job progress and the job distance is +1. Herein, assuming that the number of fixed-term direct notifications is three or less, the importance is 8 (1004 in FIG. 10) from the table (a) in FIG. 10.

Thereafter, the importance calculation section 37 repeats steps B2 to B5 for the workers to be notified and calculates an importance of change notification per worker (step B6).

Referring back to FIG. 11, a description will be given of step A5 and thereafter. The importance calculation section 37 records notification data per worker to be notified into the notification information storage section 43 (step A5). The notification data comprises Calculated Importance (901 in FIG. 9), Worker to be notified (902 in FIG. 9), and Information of Job subjected to a change (examples of 903-906 in FIG. 9). In this example, the notification data for the workers B, C, and D are 908, 909, and 910, respectively. What has been described so far is the operation common to both the direct notification and the indirect notification.

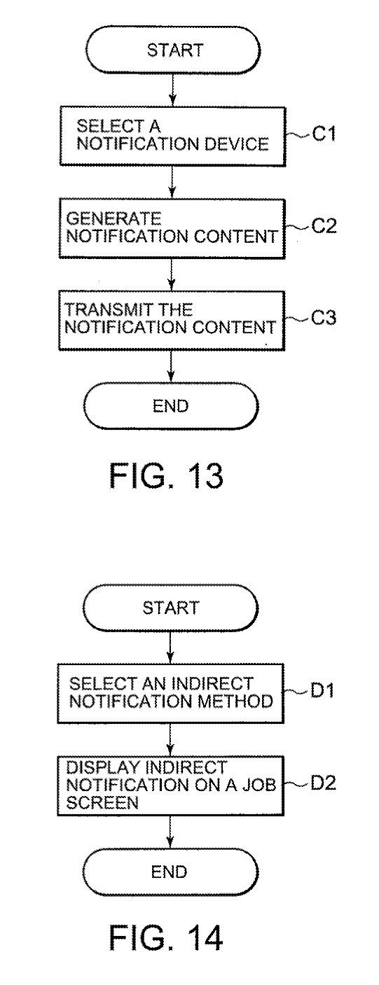

Since subsequent operations differ from each other, the operation of the direct notification will first be described with reference to a flowchart of FIG. 13. The direct notification section 35 carries out direct notification by referring to the notification data. With respect to the reference timing, the importance calculation section 37 may issue a reference command to the direct notification section 35 after registering the notification data (step A5 in FIG. 11) or the direct notification section 35 may periodically confirm whether or not there is newly recorded notification data.

First, the direct notification section 35 refers to the importance of the notification data and determines the notification device 5 for performing direct notification to the worker (step C1). Using the example of the notification data at 908 in FIG. 9, since the importance is 8, mail (804 in FIG. 8) is selected as the notification device 5 from Importance of the notification device management data (example of FIG. 8). On the other hand, using the example of the notification data at 910 in FIG. 9, since the importance is 2 and there is no notification device 5 adapted to carry out direct notification of importance 2 in the notification device management data, it is outside the direct notification.

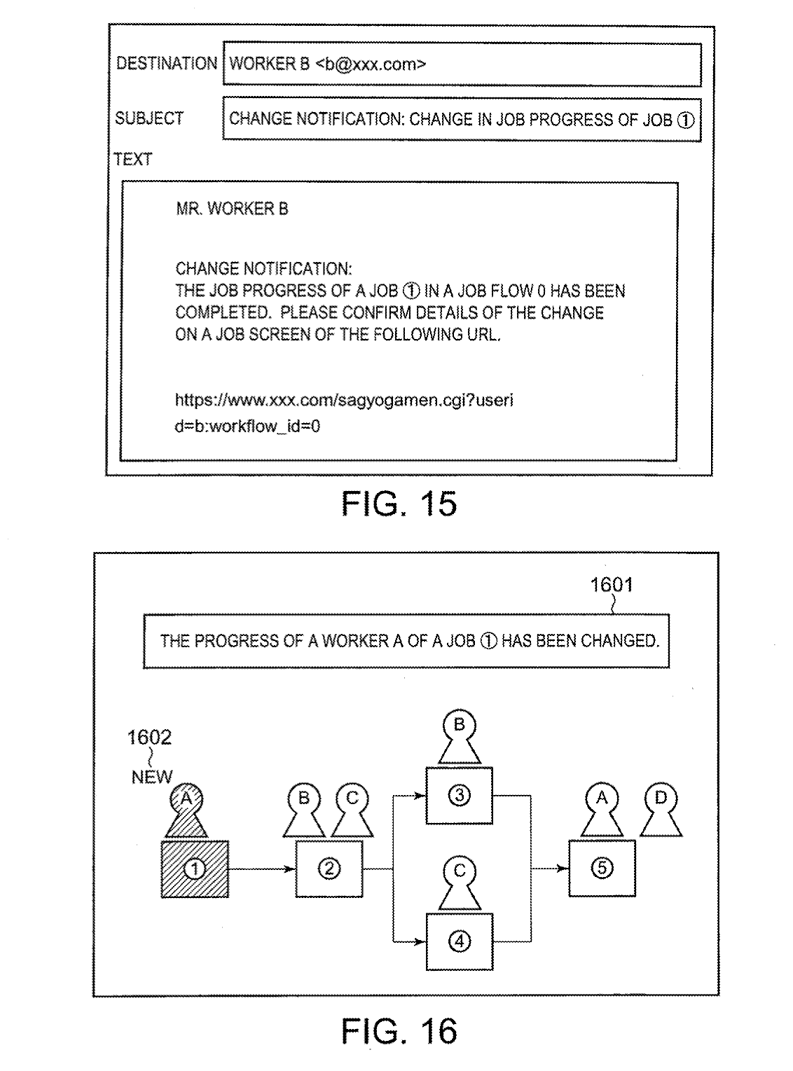

Then, the direct notification section 35 generates notification content in a format suitable for the determined notification section 5 (step C2). For example, when the notification section 5 is mail, the notification content is in a format having a subject and the text as an example of FIG. 15.

Finally, the direct notification section 35 delivers the notification content to the notification device 5 and causes the notification device 5 to transmit it to the input/output device 1 of the worker (step C3).

Next, the operation of the indirect notification will be described with reference to a flowchart of FIG. 14. As different from the direct notification in which the work management device actively carries out notification, the indirect notification operates when a worker requests a job display to the job display section 34 through the input/output device 1.

First, the job display section 34 in receipt of the display request requests a display of indirect notification to the indirect notification section 36. The indirect notification section 36 in receipt of the request refers to the importance of the notification data and determines a method of carrying out indirect notification to the worker (step D1). Using the example of the notification data at 910 in FIG. 9, since the importance is 2, indirect notification by message display (805 in FIG. 8) is determined from Importance of the notification device management data (example of FIG. 8).

In the indirect notification, as the message display (703 in FIG. 7) and the update display (704 in FIG. 7) shown in the example of FIG. 7, notification may be carried out using all notification methods corresponding to importances lower than an importance of the notification provided that a worker is not confused even if the notification is made using a plurality of means. In the case of the example at 910 in FIG. 9, notification is also carried out by update display adapted to perform indirect notification of importance 1.

Then, the indirect notification section 36 displays notification content on a job screen displayed by the job display section 34 by the use of the determined indirect notification method (step D2). In the case of the example at 910 in FIG. 9, the indirect notification section 36 displays a message display (1601 in FIG. 16) and an update display (1602 in FIG. 16), shown in FIG. 16, on a job screen of the worker D.

Hereinabove, the change notification operation has been described taking the job progress change as an example. Also in the case of a job flow change or a job staff change being another change classification, the same operation is performed except that the job progress management section 33 is changed to the job flow management section 31 or the job staff management section 32 corresponding thereto.

According to the Example 1, with respect to a job change generated in the job flow management section 31, the job staff management section 32, or the job progress management section 33, the importance judging section 37 calculates an importance based on a job classification, such as a job flow change, a job staff change, or a job progress change, of the generated job change, a distance between a job subjected to the change and a job in charge of a worker to be notified, and the number of direct notifications to the worker to be notified in a fixed period of time and properly switches between direct notification in which a device actively notifies a worker like mail or the like, and indirect notification in which notification is made when a worker displays a job screen. This makes it possible to notify each worker of the job change by an appropriate notification means according to an importance of the job change evaluated per worker.

In the example of FIG. 2, the workers B and C receive direct notification by mail because the job progress has been changed in the job 1 immediately before the job 2 in charge of the workers B and C. On the other hand, since the staff member D is in charge of the remote job 5, indirect notification by message notification and/or update notification is made when a job screen is displayed. It is to be noted that if direct notification by mail is carried out for the worker D, a lot of mails may reach before the job 5 in charge of the worker D is started and thus there is a high possibility that really important mails are buried and not recognized.

### EXAMPLE 2

A work management system 2000 being an Example 2 of this invention will be described. In the Example 1 described above, when a change in job flow, staff, or job progress occurs, it is notified to each worker as a job change. In the Example 2, addition, deletion, or update of a file relating to a job or addition of a comment to a job is further notified to each worker as a job change.

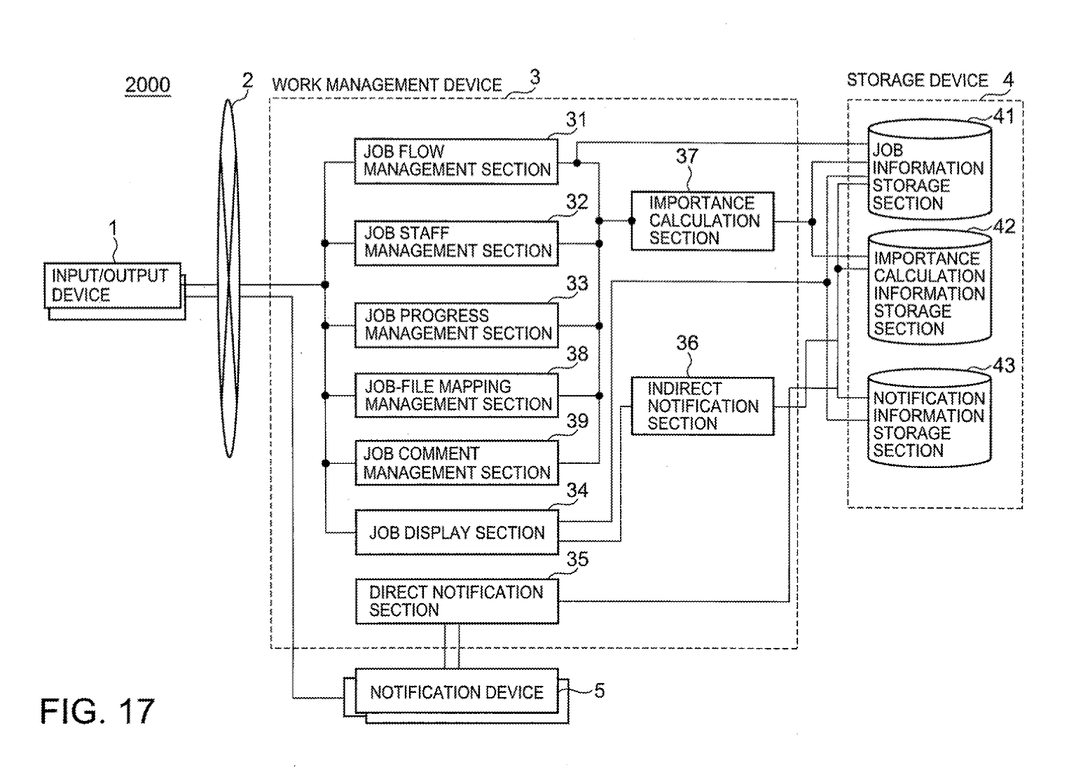

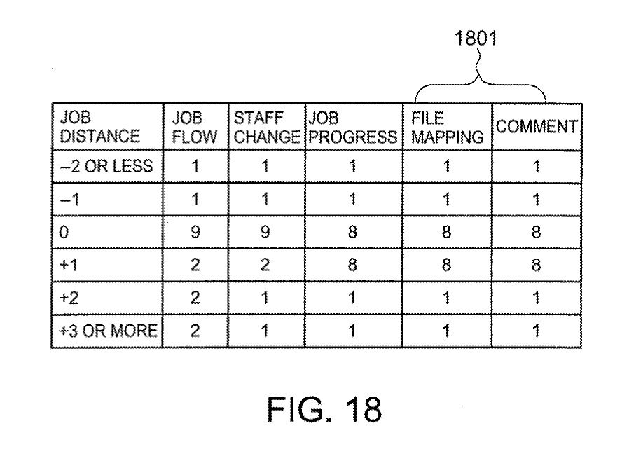

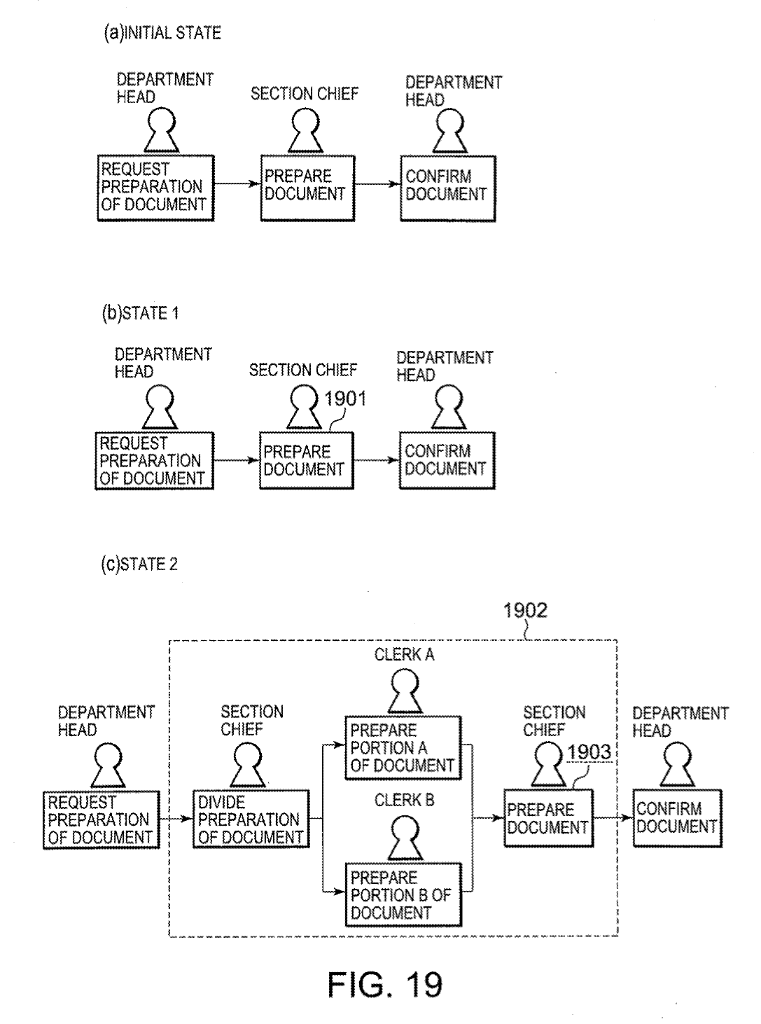

Accordingly, as shown in FIG. 17, the work management system 2000 further comprises a job-file mapping management section (38 in FIG. 17) for managing files relating to jobs and a job comment management section (39 in FIG. 17) for adding comments relating to jobs. Further, in the work management system 2000, importances corresponding to these job classifications are registered in an importance calculation table as shown at 1801 in FIG. 18. By this, according to the work management system 2000, not only upon the occurrence of a change in job flow, staff, or job progress, but also upon the occurrence of a change such as addition, deletion, or update of a file relating to a job or addition of a comment to a job, notification content is delivered to each worker by a notification means according to an importance for the worker.

### EXAMPLE 3

A description will be given of an example of managing more specific atypical jobs using the work management system 1000 of the Example 1. In this Example, as an example of the atypical jobs, use is made of a job flow in which a subordinate (section chief) prepares a document (proposal paper, budget plan, or the like) by order of a superior officer (department head). Further, the example of FIG. 8 is used as notification device management data and the importance calculation table (a) in FIG. 10 is used as an importance calculation table.

First, it is assumed that, using the job flow management section 31 and the job staff management section 32, the department head defines a job flow shown in (a) Initial State of FIG. 19 by referring to a job flow of document preparation carried out in the past.

Then, when the department head has completed a job “Preparation of Document” using the job progress management section 33, a change in job progress occurs. The importance judging section 37 calculates an importance of notification to the section chief in charge of a next job “Prepare Document” to be 8 from (a) in FIG. 10 and the direct notification section 35 transmits change notification by mail.

It is assumed that the section chief in receipt of the mail has changed the job flow such that the section chief allots “Prepare Document” being the job in his/her own charge to clerks A and B being his/her subordinates, finally combines them into a document, and sends it to the department head.

It is a feature of atypical jobs that a job flow and job staff members are progressively changed while advancing jobs as described above. Using the job flow management section 31 and the job staff management section 32, the section chief registers/changes the job flow and the job staff members as at 1902 in (c) State 2 of FIG. 19. For the clerks A and B added in the job flow, a job flow change and a staff change have occurred so that the importance judging section 37 calculates respective importances. In calculation of a job distance (step B4 in FIG. 12) for importance calculation, since the clerks A and B are not job staff members in (b) State 1 of FIG. 19 before the changes, the job distance becomes zero.

When the plurality of changes have occurred simultaneously as in this example, only change notification with a higher importance may be carried out for suppressing the number of notifications. In this case, the job flow change and the staff change have the same importance of 9 and one notification is delivered to each of the clerks A and B by mobile mail. On the other hand, with respect to notification to the department head, assuming that “Prepare Document” at 1901 and “Prepare Document” at 1903 in FIG. 19 are the same job, the job distance becomes +2 and, since the job classification is the job flow change, the importance of the change with the highest importance becomes 2. Accordingly, the indirect notification section 36 carries out indirect notification by message display and update notification to the department head when a job screen is watched using the job display section 34. Subsequently, it operates in the same manner until the completion of the entire job flow.

### ADDITIONAL REMARK

The following changes may be made to the message notification method, the work management device, the work management system, and the computer program described in “Means for Solving the Problem” described above.

The notification manners preferably include at least one of each of indirect notification in which the work management device transmits a message in response to an operation on the receiving side and direct notification in which the work management device transmits a message without waiting for an operation on the receiving side. For example, by notifying a low importance change based on indirect notification, a worker refers to it at need, while, by notifying a high importance change based on direct notification so as to make notification without waiting for an operation by the worker, it is possible to securely deliver the high importance message to the worker without bothering the worker with the low importance message. As an example of the direct notification, there is calling to a fixed phone, transmission to an electronic mail address of a personal computer or the like, calling to a mobile phone, calling to an electronic mail address of a mobile phone, or calling by fax or instant message. As an example of the indirect notification, there is WWW (World Wide Web) or an electronic bulletin board. The direct notification may be understood as notification based on push-type information delivery and the indirect notification as pull-type information delivery. See particularly FIGS. 13 and 14.

As an example of the job information, there is job flow data (FIG. 3) representing a sequence relationship of jobs performed by part or all of a plurality of workers, worker data (FIG. 4) mapping each worker to address information of the worker in one of a plurality of notification manners, job staff data (FIG. 5) mapping each worker to a job in charge of the worker, job progress data (FIG. 6) mapping each job to a progress state of the job, and a file (job object file, comment file for a job, or the like) mapped to each job. The job information may include one to all of them.

Preferably, the calculation of the importance is carried out according to at least one of a job distance representing a sequence relationship between a job in charge of a worker for whom the importance is to be calculated and a job subjected to a change, and a job classification subjected to the change. See particularly FIG. 12.

The calculation of the importance may be such that the importance is calculated according to the number of direct notifications in a predetermined period of time. See particularly (a) and (b) in FIG. 10.

Further, this invention provides a work management device that manages jobs performed by a plurality of workers, the work management device characterized by comprising a plurality of notification devices (5) of which corresponding notification manners are different from each other, a storage device (41) storing job information, means (31, 32, 33, 38, 39) for changing the job information stored in the storage device, importance calculation means (37) for calculating an importance of a change of the job information for each of the plurality of workers, and means (35, 36) for selecting one or more from the plurality of notification devices according to the importances calculated, wherein the work management device notifies each of the pertinent workers of a message relating to the change of the job information by the use of the notification device selected.

While this invention has been described with reference to the embodiment and the Examples, this invention is not limited to these embodiment and Examples. A person skilled in the art can make various changes to the above-mentioned embodiment and Examples within the technical scope of this invention.

This application claims priority from Japanese Patent Application No. 2007-045374, filed on Feb. 26, 2007, the disclosure of which is incorporated herein in its entirety.

1. A message notification method in which a work management device managing jobs performed by a plurality of workers notifies a message to part or all of the plurality of workers,
wherein the work management device comprises a plurality of notification devices of which corresponding notification manners are different from each other,
the method comprising:
a data changing step in which the work management device updates job information stored in advance in a storage device of the work management device;
an importance calculation step in which the work management device performs a process of calculating an importance of the job information changed for each of the plurality of workers;
a notification device selection step in which the work management device performs a process of selecting one or more from the plurality of notification devices according to the importance calculated; and
a notification step in which the work management device notifies each of corresponding workers of a message relating to the job information changed by the use of the notification device selected.

2. The message notification method claimed in claim 1, comprising, as the notification manners, at least one indirect notification in which the work management device transmits a message in response to an operation on a receiving side and at least one direct notification in which the work management device transmits a message without waiting for an operation on a receiving side.

3. The message notification method claimed in claim 1, wherein the job information comprises at least one of:
job flow data representing a sequence relationship of jobs performed by part or all of the plurality of the workers;
worker data relating one of the workers to address information of the one in one of the plurality of notification manners;
job staff data relating one of the workers to the job in charge of the one;
job progress data relating a job to a progress state of the job; and
a file related to a job.

4. The message notification method claimed in claim 1, wherein the importance calculation step calculates the importance according to at least one of:
a job distance representing a sequence relationship between the job in charge of the worker for whom the importance is to be calculated and the job subjected to the change; and
a job classification subjected to the change.

5. The message notification method claimed in claim 2, wherein the importance calculation step calculates the importance according to the number of direct notifications in a predetermined period of time.

6. A work management device that manages jobs performed by a plurality of workers, the work management device comprising:
a plurality of notification devices of which corresponding notification manners are different from each other;
a storage device storing job information;
means for changing the job information stored in the storage device;
importance calculation means for calculating an importance of the job information changed for each of the plurality of workers; and
means for selecting one or more from the plurality of notification devices according to the importances calculated,
wherein the work management device notifies each of the pertinent workers of a message relating to the job information changed by the use of the notification device selected.

7. A work management device according to claim 6, wherein the notification manners include at least one of each of indirect notification in which the work management device transmits a message in response to an operation on a receiving side and direct notification in which the work management device transmits a message without waiting for an operation on a receiving side.

8. A work management device according to claim 6, wherein the job information includes at least one of:
job flow data representing a sequence relationship of the jobs performed by part or all of the plurality of workers;
worker data mapping each worker to address information of the worker in one of the plurality of notification manners;
job staff data mapping each worker to the job in charge of the worker;
job progress data mapping each job to a progress state of the job; and
a file mapped to each job.

9. A work management device according to claim 6, wherein the importance calculation means calculates the importance according to at least one of:
a job distance representing a sequence relationship between the job in charge of the worker for whom the importance is to be calculated and the job subjected to the change; and
a job classification subjected to the change.

10. A work management device according to claim 7, wherein the importance calculation means calculates the importance according to the number of direct notifications in a predetermined period of time.

11. A work management system comprising a communication network, a plurality of input/output devices connected to the communication network, and a work management device connected to the communication network, the work management system wherein:
the work management device is the work management device according to claim 6;
the means for changing the job information changes the job information in response to an input operation of the input/output device; and
the selected notification device notifies each of the pertinent workers of the message relating to the change of the job information through the communication network and the input/output device.

12. A computer program that causes a computer to perform a work management process for managing jobs performed by a plurality of workers, the computer comprising:
a plurality of notification devices of which corresponding notification manners are different from each other, the computer program causing the computer to execute;
a step of changing job information stored in advance in a storage device;
an importance calculation step of calculating an importance of the job information changed for each of the plurality of workers;
a step of selecting one or more from the plurality of notification devices according to the importances calculated; and
a step of notifying, by the work management device, each of the pertinent workers of a message relating to the job information changed by the use of the notification device selected.

13. A computer program according to claim 12, wherein the notification manners include at least one of each of indirect notification in which the work management device transmits a message in response to an operation on a receiving side and direct notification in which the work management device transmits a message without waiting for an operation on a receiving side.

14. A computer program according to claim 12, wherein the job information includes at least one of:
job flow data representing a sequence relationship of the jobs performed by part or all of the plurality of workers;
worker data mapping each worker to address information of the worker in one of the plurality of notification manners;
job staff data mapping each worker to the job in charge of the worker;
job progress data mapping each job to a progress state of the job; and
a file mapped to each job.

15. A computer program according to claim 12, wherein the importance calculation step calculates the importance according to at least one of:
a job distance representing a sequence relationship between the job in charge of the worker for whom the importance is to be calculated and the job subjected to the change; and
a job classification subjected to the change.

16. A computer program according to claim 13, wherein the importance calculation step calculates the importance according to the number of direct notifications in a predetermined period of time.
